(19) United States
(12) Patent Application Publication
(10) Pub. No.: US 2007/0063024 A1
(43) Pub. Date: Mar. 22, 2007

(54) Dual macro- and micro-payment card system

(75) Inventor: Carles Guillot, New York, NY (US)

Correspondence Address: DLA PIPER RUDNICK GRAY CARY US, LLP, 2000 UNIVERSITY AVENUE, E. PALO ALTO, CA, 94303-2248, US

(73) Assignee: Plastyc Inc.

(21) Appl. No.: 11/524,732

(22) Filed: Sep. 20, 2006

Related U.S. Application Data
(60) Provisional application No. 60/719,260, filed on Sep. 21, 2005.

(51) Int. Cl. G06K 5/00; G06Q 40/00

(52) U.S. Cl. 235/380; 705/44

(57) ABSTRACT

An electronic transactions system suitable for payment services wherein certain merchants needing to accept online micro-payments from holders of mainstream payment cards are equipped with an online Point Of Service system capable of communicating directly with an operator acting on behalf of the issuer of the cards of the payers via a dedicated data communication protocol to obtain an authorization for micro-payments without transiting through a separate acquirer and interchange network, whereas the card-holder payer needs only to fund a single account for both micro-payments with those certain merchants and regular payments with all other merchants where their card is accepted.

### PRIORITY CLAIM

This application claims priority under 35 USC 119(e) and 120 to U.S. Provisional Patent Application Ser. No. 60/719,260 filed on Sep. 21, 2005 and entitled “Dual Macro- and Micro-Payment Card System” which is incorporated herein by reference.

### FIELD OF THE INVENTION

The present invention relates to electronic transaction systems, and particularly to a combination of electronic authorization protocols suitable for implementing payment transactions between a multiplicity of merchants and an issuer of a payment instrument applicable for both standard purchases of physical goods, and micro-purchases of digital goods, where a plastic card is issued to the payer to materialize the electronic account being used to fund all purchases.

### DESCRIPTION OF RELATED ART

Card payment systems are commonplace, allowing users to make payments using a credit or debit card. While credit card charges accumulate debt that the cardholder needs to settle periodically, debit card charges draw money from the funds available in an account. The terms “charge card” or “payment card” will be used herein below to relate to both credit and debit cards.

A charge card is associated with an account that is established with and managed by a card issuer. The card issuer is an entity that manages payments on behalf of the cardholder, and can be a bank, credit card company, telephone company, workplace, school, etc. The charge card is accepted by participating merchants, who sign with a transaction acquirer, which can be the same or other than the card issuer. In a typical transaction, the merchant calculates the payment amount, the cardholder submits his card for payment, the card adequacy to pay is verified by a process called “authorization”, which is usually supported by a real-time electronic communication protocol between the merchant, the acquirer and the issuer, the payment particulars are recorded in the form of computer-readable transaction data records by the merchant's POS (Point Of Service), and then, either in real time or as part of an end-of-day procedure, the transaction records are sent electronically from the merchant to his acquirer for settlement. The transaction is finalized when the acquirer settles with the card issuer (if the issuer is another entity), and funds are transferred to the merchant's account on the one hand, and are charged to the cardholder's account on the other hand. Often the amount transferred to the merchant's account is slightly smaller than the one charged to the cardholder's account, the difference being a fee collected by the issuer, acquirer and/or an interchange network between the acquirer and the issuer.

The card is a means for a cardholder to identify his account and authorize transactions therewith. It can have the well-known form factor of a plastic card with embossment and magnetic stripe; it can be a contact or contact-less smart card having a variety of form factors such as plastic card or a key fob; it can even be just a record of account details used for performing electronic transactions over the Internet or a cellular network.

FIG. 1 is a schematic block diagram that describes an exemplary card payment system 100 of the background art. A payment card 104 related to user account 120 makes a payment transaction 108 in the amount of X dollars with a merchant POS 112. The merchant POS 112 contacts merchant's acquirer 35 for making authorization 116 via a pre-arranged data communication protocol. The acquirer contacts in turn the card interchange network 25 to obtain the authorization from issuer 15 via the data communication protocol 355. If the transaction is successfully authorized, the cardholder receives his merchandise or service from the merchant (not shown). The transaction is ultimately completed when the funds transfer 138 of X dollars minus a fee MF charged to the merchant is received through settlement network 40 by merchant account 160 associated with POS 112.

Of a special interest to the present invention are merchants who sell items of small monetary value, for which the fees MF charged by ordinary acquirers of card transactions represent a prohibitively high percentage of the items price. FIG. 2 shows the typical structure of a fee 200 charged to merchants for card payment processing, where the merchant fee MF is comprised of a fixed amount 210 to which a percentage amount 220 of the purchase amount is added. Typical fees 200 are devised to represent an acceptable overall percentage of most common card transactions, for example 2.5% or less. However, when the price of the good or service being sold is small, the fee incurred by the merchant accepting the card as a payment instrument can be in excess of 10% of the value of the transaction because the fixed factor 210 becomes preponderant, thus making card payments non viable for small-ticket low-margin commerce. For example, it is customary that fixed factor 210 be in the vicinity of $0.25, thus representing 25% of a $1 transaction. It should be noted that the fee MF charged to the merchant is intended to cover all the service costs incurred by the participants of charge back-end system 130 of FIG. 1, i.e. the acquirer, interchange network and issuer, and not just the acquirer.

Costs incurred by merchants for ordinary card transactions are often higher for online merchants which sell goods and services over an Internet storefront, because the transactions are deemed to be “card-non-present-transactions”, which are typically riskier than “card-present-transactions” at a physical retail Point Of Service. During a card-present-transaction, the merchant is given the opportunity to verify by itself a number of credentials about the card holder, such as that the matching of the signature at the back of the card against the card-holder's signature on a paper receipt, or the matching of the name printed on the face of the card against a requested card-holder proof-of-identity. Such verifications by the merchant are not available during an online purchase, thus increasing the risk that the card involved may not be legitimate or may have been stolen. Hence, transaction acquirers typically charge merchants a higher fee for such card-non-present-transactions, by increasing the percentage amount 220, and sometimes the fixed amount 210 as well.

FIG. 3 is a schematic block diagram that describes an exemplary card-non-present payment system 300 of the background art. A personal computer 305 is used to browse and select a desirable good or service from a merchant's web storefront server 311, where the personal computer and the merchant server communicate remotely with each other via the Internet 306. Once the desired good or service is selected, a payment card 104 on the personal computer side makes a payment transaction 308 with a merchant POS 312 via the merchant storefront 311. The merchant POS 312 contacts charge back-end system 130 for making authorization 316, which is considered a card-non-present authorization. If the transaction is successfully authorized, the cardholder receives his merchandise or service from the merchant (not shown).

Online merchants of small-value digital items like digital music, ring-tones for Mobile Phones or casual video games for Personal Computers or Game Consoles or Mobile Phones are thus doubly impacted by card fees: once because the fees amount to a naturally high percentage of the price of their wares, and a second time because they sell through card-non-present transactions.

A number of dedicated electronic transactions systems have been devised to support payment transactions for merchants of small-value items; some of those systems have been specifically devised to serve online merchants. In the background art, such systems are often referred to as micro-payment systems, and can be broadly classified along two categories:

Acceptance-side micro-payment systems are electronic transaction systems which rely on, and are compatible with existing issued payment schemes and associated acceptance brands. One sub-category of such transaction systems relies on the attempted aggregation of a multiplicity of small-amount transactions within a given period of time (e.g. a few days) while the payer may be using a standard-issue payment instrument and may be unaware of the ongoing aggregation. Such aggregation may be carried out within one particular merchant (e.g. the commercial system of Apple iTunes) or across multiple merchants (e.g. a commercial system known as Peppercoin 2.0). Another sub-category of acceptance-side systems involves existing “brick-and-mortar” retailers distributing gift cards purchased with cash or standard-issue payment cards, the stored value inside the gift cards being subsequently used for micro-purchases at the further merchants of small-value items.

Intermediary account micro-payment systems which rely on participating merchants being equipped with a special-purpose POS terminal using a dedicated protocol and associated dedicated payment acceptance brand to access the fiduciary value in the intermediary account. The intermediary account can itself be funded in a prepaid or post-paid manner by a standard-issue card. Some commercial systems like the Visa-Starbucks “Duetto” card combine the intermediary account for small value items available at one given merchant—in this case Starbucks coffee shops—and a general purpose payment card in one single package, where the intermediary account can be reloaded with the general purpose card.

Reference is made to Table 1 which provides examples of commercially deployed systems of the background art in each of the two categories of acceptance-side systems and intermediary-account systems.

Further reference is made to FIG. 4 where acceptance-side transaction systems and intermediary-account transaction systems are shown relative to the three domains of typical electronic transactions systems used for payments, i.e. the Merchant Domain 30, the Interchange Domain 20 and the Issuer Domain 10. As shown in FIG. 4, a majority of the known systems of the background art are implemented solely in the Merchant Domain and rely on existing card systems from the Issuer Domain to provide funding via the Interchange Domain. Only micro-payment systems based on smart cards holding an electronic purse in their embedded micro-chip fall in the category of Issuer Domain systems. The domain to which a system belongs is of particular relevance to the usefulness of any payment mechanism because payers need to be able to easily match the instrument that they have been issued with the instruments that are accepted by merchants. Card interchange networks of the background art have fostered the deployment of billions of cards with recognizable brands which can easily be matched with decal, signage and logos at retail and online merchants accepting those brands.

FIG. 5 zooms onto intermediary-account transaction systems 500 of the background art based on getting the payer to fund a special stored-value account containing monetary value, which can be accessed by one or various participating merchants through a special data communication protocol without involving the type of charge back-end systems 130 found in typical card payment schemes. The stored-value account may be a combination of a software program and data storage located on a computer server and accessed by the merchant through an online protocol, for example over the Internet. A personal computer 305 is used to browse and select a desirable good or service from a merchant's web storefront server 311, where the personal computer and the merchant server communicate remotely with each other via the Internet 306, typically with a protocol of the background art like the Hyper-Text Transfer Protocol or “HTTP”. Once the desired good or service is selected, the user elects to pay with his or her micro-payment stored-value account 341 hosted in a server 340. This election triggers the redirection 507 of the Internet session towards the stored-value account server 340, which in turns authenticates the user of the account 341 by communicating back to the personal computer 305 via session 510. The stored-value account server provides the authorized payment confirmation 509 to the merchant store-front 311. The cardholder receives his merchandise or service from the merchant (not shown). The stored-value account can be pre-funded through transaction 503, as in commercial systems PayPal and BitPass. The stored-value account can also be post-paid through transaction 504. Some such systems of the background art aggregate transactions over a given period of time before requiring payment from the funding account, as with commercial system Click&Buy.

A variation of intermediary-account systems locates the stored-value inside the memory of the micro-computer chip of a smart card 501 as illustrated in FIG. 5 of the background art, instead of an online server, making the value accessible by merchants through non-connected POS terminals. In this case, the funds may actually be reserved at the issuer level. While such system may be optimized for card-present transactions, it remains highly impractical for remote on-line transactions as the stored value of the chip in the smart card has to be connected to the PC of the user through a specific reader and associated software.

FIGS. 6 and 7 zoom onto acceptance-side micro-payment systems of the background art based on aggregating “behind-the-scene” a series of consecutive small-amount transactions into a single larger-value transaction, which is then processed by an ordinary charge back-end system. In this way, the fee is incurred on the cumulative value of the plurality of small transactions, and in particular the fixed factor 210 of FIG. 2 is incurred only once. Sometimes, aggregation is carried out at the level of the merchant POS 612 by the merchant itself, as illustrated in FIG. 6 of the background art, thus making the system effective only if consecutive transactions 608 are done at the same single merchant. The merchant incurs a risk of not being paid as long as the cumulative amount of transactions has not reached the threshold for triggering an authorization request to the charge back-end system.

Other aggregation systems of the background art attempt to aggregate micro-transactions across a plurality of merchants POS systems 712 as illustrated in FIG. 7, before passing on a cumulative charge 134 to the user account 150; a intermediary aggregation system 730 takes responsibility for collecting the plurality of micro-transactions and aggregating them into a single larger transaction.

Another type of acceptance-side system relies on the digital merchants 310B of FIG. 4 distributing disposable gift cards 123 through physical retailers 310A. The value on such cards can only be spent at the digital merchant 310B who issued the card. Funds on the card can usually be spent by providing the activation code of the card at the merchant web-site.

General limitations and drawbacks of systems listed above include:

Generally, intermediary-account micro-payment systems face the limitation of getting consumers to register with a dedicated account which can only be used at a limited number of participating merchants. Such limited acceptance of a financial instrument that requires special registration goes against the basic principle that a payment instrument should be as widely accepted as possible to be successful with payers. Such limitation can only be overcome by a huge marketing expenditure to attempt to gain recognition as a new acceptance brand separate from existing mainstream card payment systems or cash.

More generally, systems relying on prepayment as a funding mechanism, whether online or offline, remain by nature confined to the “Merchant Domain” therefore requesting payers to reserve funds for payments to be made at one or various participating merchants. They have thus encountered considerable obstacles to adoption.

Acceptance-side systems relying on distribution of disposable gift cards face the obstacle of getting consumers to buy the card at participating retailers while content is sold at another location, namely the digital merchant's web-site. For digital merchants selling content also available as physical products such as on-line music versus CDs or on-line games versus console cartridges or discs, consumers might just as well prefer a “one-step” buying experience and purchase the content directly from a physical retailer.

A limitation of all systems listed above, with the exception of merchant gift cards, lies with the inability of teen-agers, who are the most prone to making small-value purchases given their limited spending power, to use such systems because they are generally unbanked and have no credit cards;

Acceptance-side systems implementing micro-purchase protocols in order to aggregate transactions behind-the-scene and across multiple merchants have the drawback of losing the detailed history of individual payment transactions with individual merchants, when the statement of past transactions is provided to the payer for review, thus making subsequent potential disputes difficult or impossible to handle. Posting the aggregated amount on the payer's statement under a dedicated brand name, for example with an optional Internet address to access transaction details, is also very confusing as this brand name was invisible to the payer at the time of the transaction. In some cases, such cross-merchant aggregation is also considered to create the notion of a “super merchant” and is considered to be against the rules of certain mainstream payment systems.

Systems based on aggregation strategies are exposed to the natural failure of reducing the fees incurred by the merchant and/or the cost of funding incurred by the payer when a single low-amount transaction is carried out and no aggregation can take place.

As purchases of digital products like MP3 musical tracks which can be bought online are of high interest to teen-agers who do not have bank accounts, some financial institutions have devised prepaid payment cards which are funded by parents or custodians, and behave like any other debit card when presented at a retail or online merchant. Examples of such commercially available prepaid teen card products include VisaBuxx, PayJr and AllowCard. However, such systems only solve the problem of teen access to money that can be spent online; they do not alleviate the problem of the high fees associated with small-value card-non-present purchases because they don't feature any micro-payment capabilities.

Attempts to perform transaction aggregation at one or across multiple merchants incur an additional hurdle when the payer is a teen equipped with a prepaid debit card. As these cards usually carry a small balance, the merchant or third-party payment provider runs a high risk of seeing the transaction being declined when the aggregated amount is presented to the payment network. This holds true even if an authorization request was performed prior to the user starting to make purchases, as in the mean time the balance on the debit card may have decreased to become lower than the value of the aggregated amount submitted to the network.

There is thus a need for, and it would be advantageous to have, card-based payment solutions that are backwards compatible with existing card payment infrastructures so that payers do not have to operate explicitly a separate card or separate account, while enabling merchants of low-priced items, and in particular online merchants of digital goods, to accept payments from holders of such cards without incurring the traditional costs charged to them by card transaction acquirers and without having to implement acceptance-side aggregation strategies, while making such payment solution also available to teen-agers who represent a large part of the target audience of micro-payers.

### BRIEF DESCRIPTION OF THE DRAWINGS

The present invention will be understood and appreciated more fully from the following detailed description, taken in conjunction with the drawings in which:

FIG. 1 is a simplified block diagram describing a generic electronic transactions system implementing card payments of the background art.

FIG. 2 is a description of a typical merchant fee structure of the background art.

FIG. 3 is a simplified block diagram describing a card-non-present online transaction architecture of the background art.

FIG. 4 is a simplified block diagram showing how various electronic transactions systems of the background art implementing payment services are architected along the three domains of the Issuers, Interchange and Merchants.

FIG. 5 is a simplified block diagram describing an intermediary-account based electronic transactions system using a stored-value account server or a stored-value account smart card to implement micro-payment

FIG. 6 is a simplified block diagram describing an electronic transactions system of the background art based on merchant-level aggregation of micro-transactions to implement micro-payment services.

FIG. 7 is a simplified block diagram describing an electronic transactions system of the background art based on cross-merchant aggregation of micro-transactions to implement micro-payment services.

FIG. 8 is a simplified block diagram of an electronic transactions system supporting card payments with micro-transactions capabilities according to a preferred embodiment of the present invention.

FIG. 9 is a simplified block diagram depicting the various technical entities in each of the macro-transaction and micro-transaction domains of an electronic transactions system according to the present invention.

FIG. 10 is a simplified block diagram depicting the main functionalities of a dual-payment single-card enablement computer system module according to the present invention, as a function of the user authentication capabilities of the participating merchant.

FIG. 11 is a simplified block diagram of a preferred embodiment of a dual-payment single-card enablement computer system module according to the present invention, when backwards compatibility with a prior intermediary-account based micro-payment system is desirable.

FIG. 12 is a simplified block diagram of a preferred embodiment of the present invention where data elements describing the micro-payment electronic transactions are also transmitted via the macro-payment domain so that the interchange network is aware of all electronic transactions, both micro and macro.

FIG. 13 is a table listing various data elements of the micro-payment electronic protocol according to the present invention.

FIG. 14 is a simplified block diagram depicting the main functionalities of a dual-payment single-card enablement system module according to the present invention, associated with a prepaid card processing platform of the background art, including a depiction of the various data communication protocols between those two systems and the other entities involved in both the funding of the account and in the micro-paying for purchases.

FIG. 15 is a simplified flow chart of principal actions undertaken for authorizing electronic transactions during regular purchases as well as during micro-purchases at select merchants.

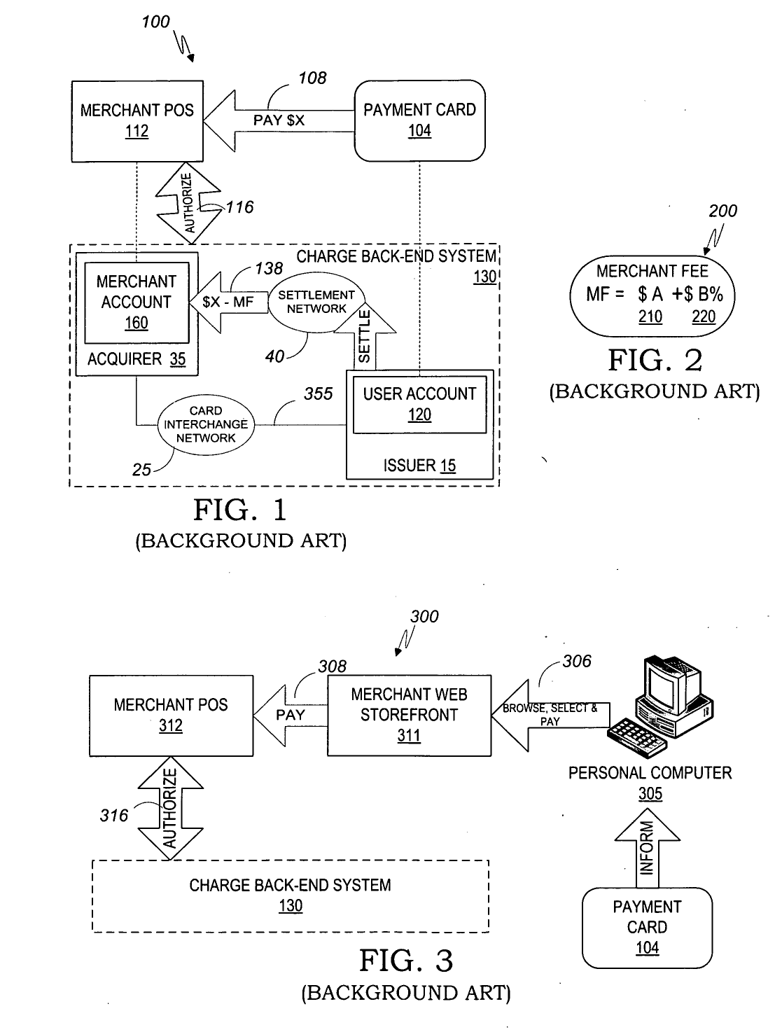

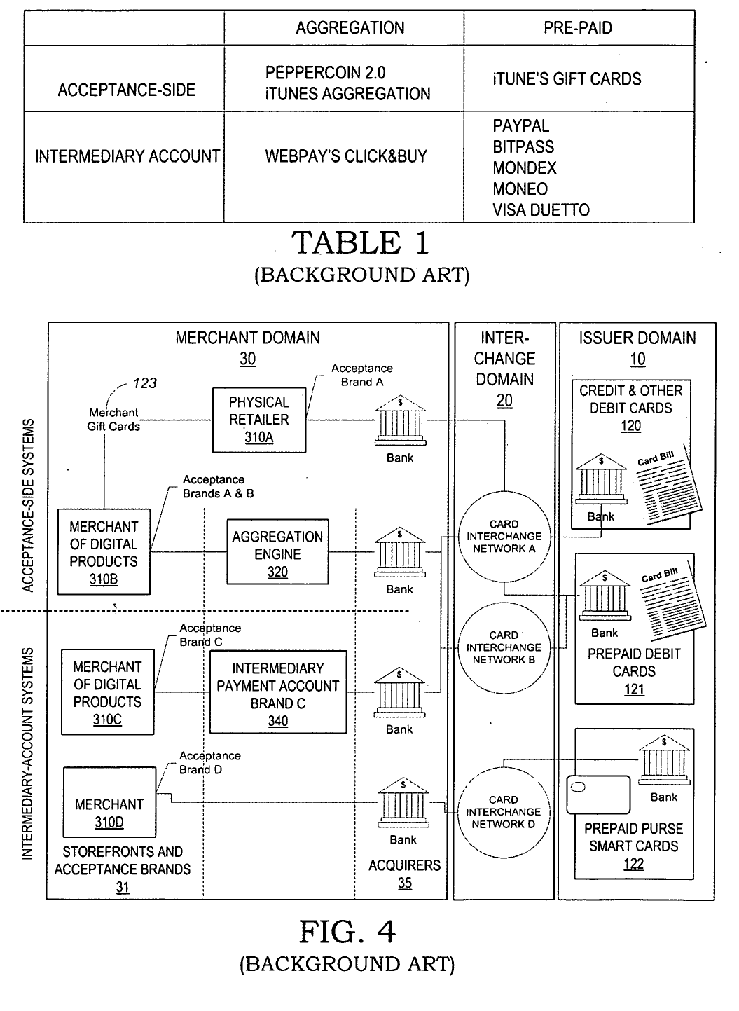

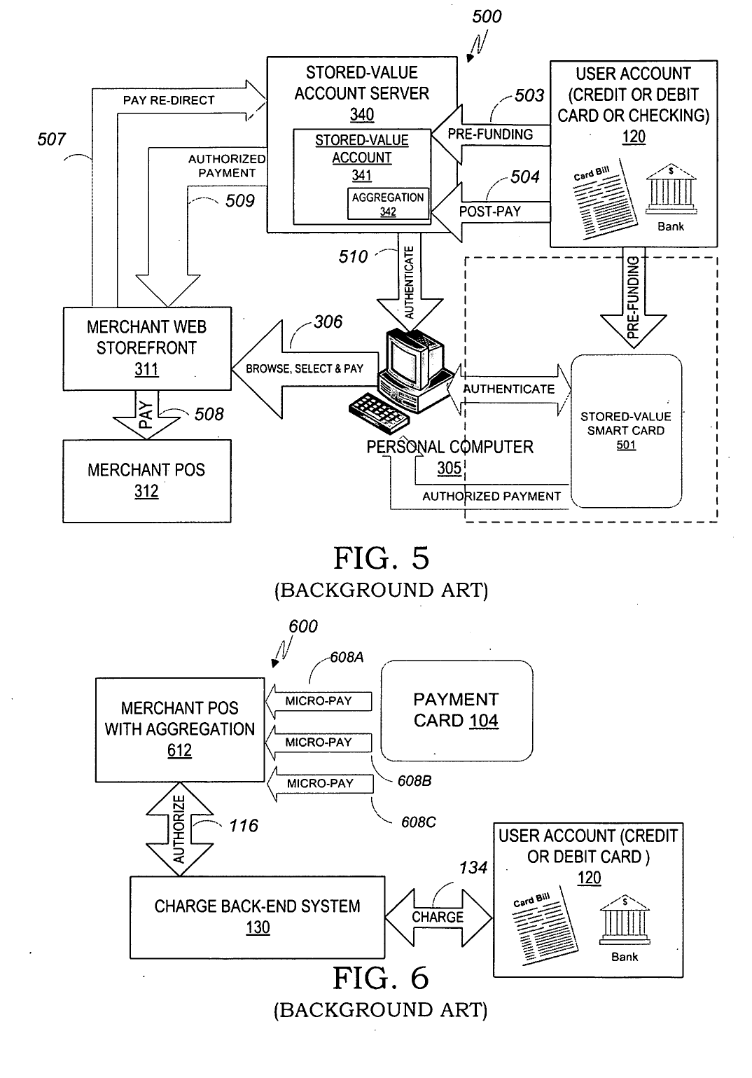

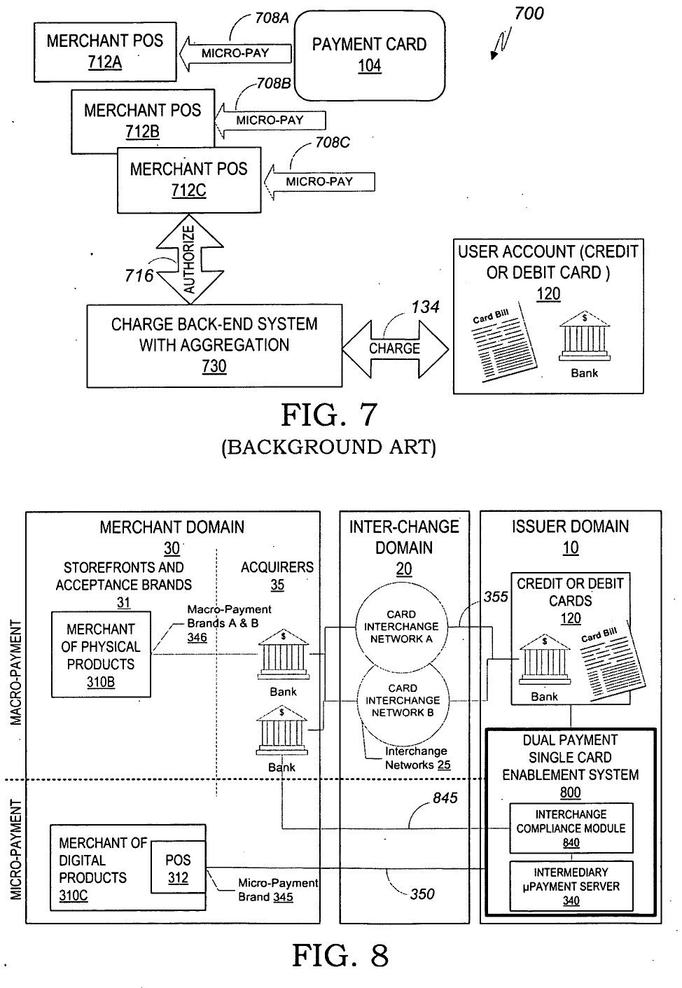

### DETAILED DESCRIPTION OF AN EMBODIMENT

The system and method provide electronic transactions systems and functionalities for allowing online merchants of small-value items to be paid by holders of mainstream charge cards. The system may eliminate the need for aggregation of micro-transactions by the merchant or across several merchants, therefore reducing the risk that transactions may fail at settlement time after an aggregation attempt, in particular in the case of prepaid accounts. The system may also eliminate the need for payers to fund and access explicitly an intermediary account separate from the issued card. The system may also alleviate the costs that would otherwise be incurred when running transactions through standard electronic transaction protocols typically used for higher-value items in customary card payment systems of the background art.

In its broadest sense, and in reference to FIG. 8, the present invention provides for a micro-payment electronic communication protocol 350 between certain digital merchants 310C selling, among other things, small-value items, and a charge card account computer system 120 of the Issuer Domain 10, which can also be used to make ordinary purchases from any of merchants 310B via mainstream Interchange Systems 20 and standard electronic payment protocol 355. For example, a charge card based on the system of the present invention, can be used indifferently to purchase clothing at a retail store, books at an online merchant, or individual tracks of music from an online portal for download into a Personal Computer or Mobile Phone.

There is thus provided, in accordance to preferred embodiments of the present invention, an electronic transactions system where dedicated data communication protocol 350 optimized for the payment of small-value items is exposed to POS 312 of Merchant 310C via Dual-Payment Enablement Computer System 800 under the control of the Issuer Domain 10, thus eliminating the need for a new Acquirer 35 to be involved in processing the micro-transactions, as well as avoiding the need for the existing Acquirers of merchants 310B or 310C to handle micro-transactions.

There is also provided, according to preferred embodiments of the present invention, a Dual-Payment Enablement Computer System 800 which can include optionally existing Intermediary Micro-Payment Computer Server 340 of the background art, in order to provide backwards compatibility with existing intermediary-account based systems and their associated acceptance brands. For example, a charge card account based on the system of the present invention, can operate with both established macro-payment acceptance brands 346 and established micro-payment acceptance brand 345.

There is also provided, according to preferred embodiments of the present invention, a unified account computer management system and associated card activity data reporting system related to card account 120 where the card-holder can view both the data representing standard purchases made via standard protocol 355 and the data representing online micro-purchases made via the micro-payment protocol 350, all related to a single account, and as if they had all been carried out through the same electronic authorization protocol.

There is also provided, according to preferred embodiments of the present invention, a Dual-Payment Enablement Computer System 800 which can include optionally Interchange Compliance Module 840 for making data communication networks of interchange domain 20 aware of micro-transactions by transmitting through them from time to time transaction data 845 representing a cumulative amount of micro-transactions otherwise run via data communication protocol 350.

There is also provided, according to preferred embodiments of the present invention, an electronic transactions system where the unified account computer system 120 capable of handling transactions with both the standard electronic payment protocol and the micro-payment optimized electronic communication protocol, is a pre-paid account, which minimizes the cost of funding isolated micro-transactions coming through the micro-payment protocol.

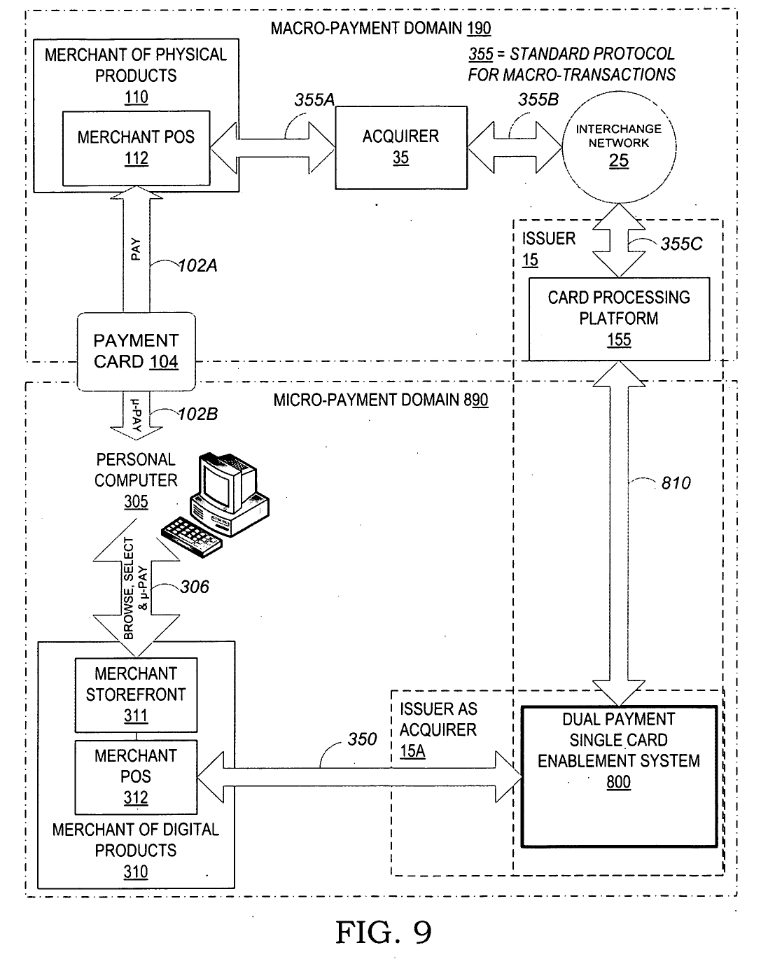

Reference is made to FIG. 9, which schematically describes a card payment system according to the present invention. FIG. 9 is divided up into the macro-payment domain 190, where ordinary card purchases take place at existing merchants, and the micro-payment domain 890 where card purchases optimized for small value items take place at specific merchants. In the macro-payment domain 190, a payment card 104 can be presented in person (102A) to pay for products to be purchased from merchant of physical products 110. The merchant POS 112 seeks an authorization from the card issuer 15 via acquirer 35 and interchange network 25, using electronic data communication protocol 355. Issuer 15 uses the card payment processing computer platform 155 (which may be operated by a specialist third party payment processor, not shown here) to confirm the credit worthiness of the holder of card 104, if the card is a credit card, or to confirm the presence of available funds in the account of the card holder if the card is a debit card. A response is provided back to the merchant 110 via the interchange network and acquirer. The merchant can then hand out or ship the product(s) (not shown).

In the micro-payment domain 890, the same card 104 can be also presented online (102B) via a Personal Computer 305 or any other suitable terminal device, and the Internet 306 to a merchant of digital products 310 after having browsed and selected the desired product through the merchant's electronic storefront 311. This time, the data elements representing the authorization request for the transaction are passed by merchant POS 312 on to dual-payment single-card enablement computer system 800 operated by the issuer acting as acquirer 15A, via the micro-payment optimized data communication protocol 350. The dual-payment single-card enablement computer system 800 in turn interacts with the card payment processing computer platform 155 to approve or deny the transaction, via data communication protocol 810. The merchant can then download the product(s) into the payers Personal Computer (not shown).

Whereas elements and processes described within the macro-payment domain 190 should preferably be backwards-compatible with those found in the background art, it should be noted that the present invention relates to the particular combination of the computer hardware and software elements and data communication protocols of micro-payment domain 890 to those of domain 190 and their combined interactions. It should also be appreciated that transactions handled through micro-payment domain 890 need not be technically restricted to small value purchases, if it is found to be commercially acceptable by the participants to route certain higher-value transactions through data communication protocol 350.

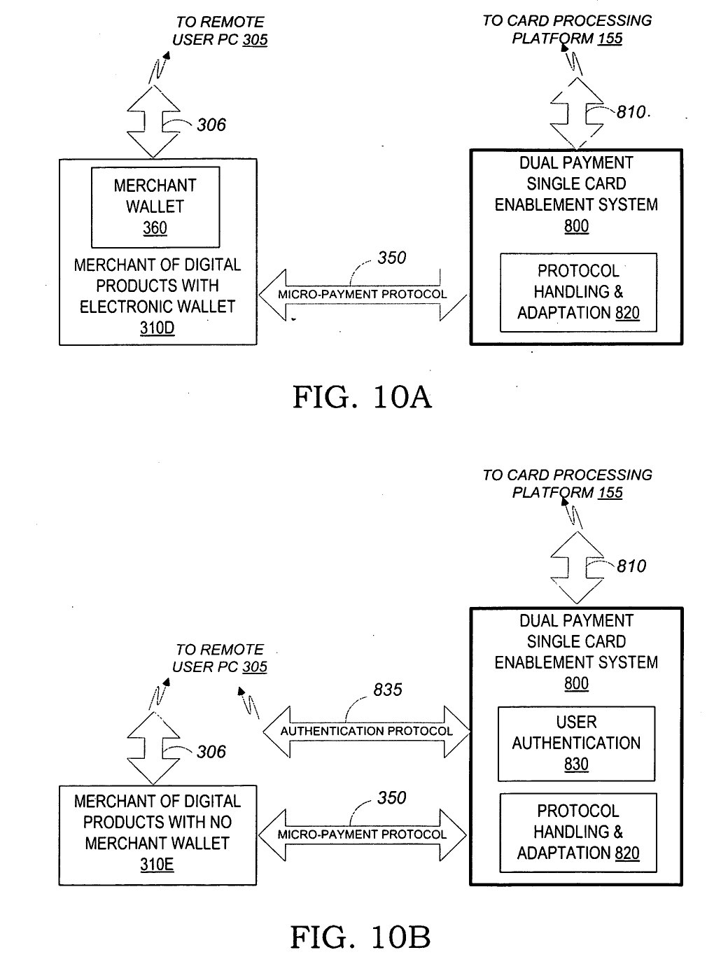

FIG. 10A and FIG. 10B describe main functions of the dual-payment single-card enablement computer system 800 of FIGS. 8 and 9 in more details, depending on the capabilities of merchants to securely authenticate end users.

FIG. 10A shows a merchant 310D with a built-in electronic wallet 360 of the background art capable of storing end-user data elements such as shipping address, billing address, and payment card details. Such electronic wallets include the ability to perform an online user authentication protocol in order to guarantee that the contents of the wallet are only accessed by the legitimate end users. With such merchants able to ascertain the identities of remote end users through their own electronic wallet system 360, the dual-payment single-card enablement computer system 800 does not need to authenticate the end user further before processing an online micro-transaction. Its main function is thus to handle the data communication protocol 350 and adapt it for further electronic communication with the card processing computer platform 155, through Protocol Handling & Adaptation Module 820. By way of example, data communication protocol 350 may carry data elements such as Digital Product Identification data intended for later dispute resolution purposes in case of failed download of the purchased digital product towards the card-holder; such data elements can be used also for future bill presentment purposes, but are typically not used by card processing computer platforms 155 of the background art. A main service provided by Protocol Handling & Adaptation Module 820 is to extract from protocol 350 the requests to decrement the balance of the card by small amounts (micro-purchases) and pass such requests in a form appropriate for the card processing computer platform 155.

By contrast, FIG. 10B shows a merchant 310E with no built-in electronic wallet of the background art capable of online user authentication. In that case, the dual-payment single-card enable computer system 800 needs to also authenticate the card-holder on behalf of the Issuer 15 of FIG. 9, through User Authentication Module 830 module and data communication protocol 835 since the merchant 310 is confronted to a card-non-present transaction and cannot ascertain the ownership of the card by itself. By way of example, the electronic authentication protocol 835 can be carried over the Internet between computer platform 800 and end-user PC 305, requesting a username and password through an encrypted session. Other more sophisticated forms authentication of the background art not shown here could be implemented by module 830, such as stronger-than-password user authentication or two-way authentication providing some immunity against server impersonation attacks.

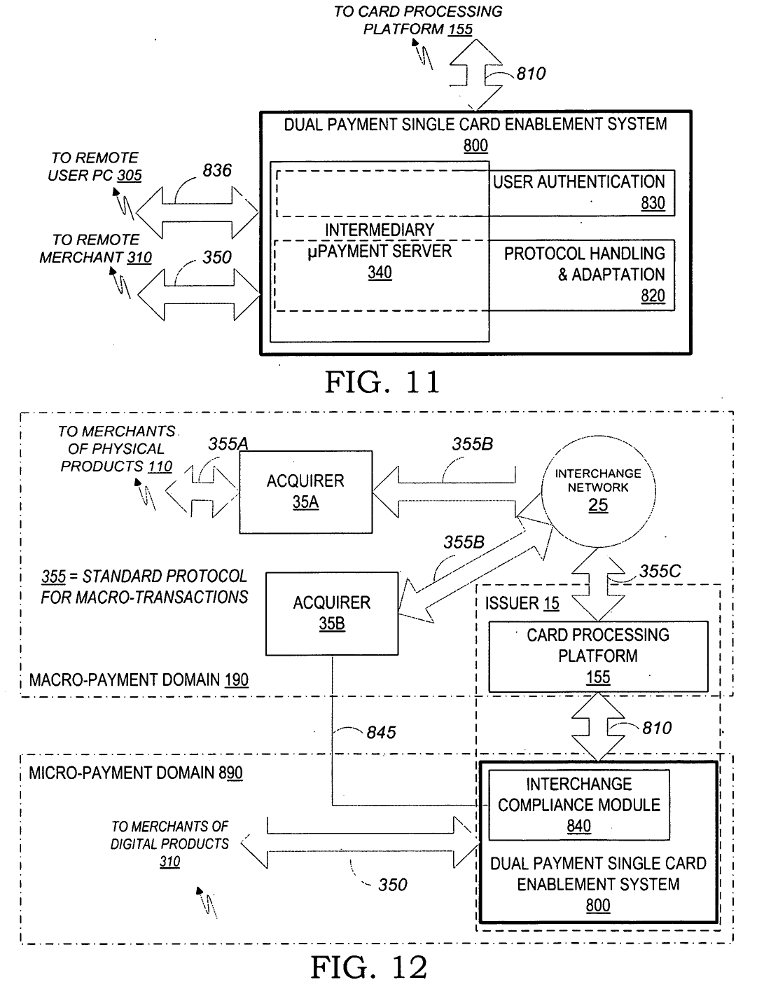

FIG. 11 shows yet another implementation of a dual-payment single-card enablement computer system 800, in the case where compatibility with a prior intermediary-account based micro-payment system of the background art is desirable, in order to not have to deploy a new set of merchant POS's 112 of FIG. 9. Intermediary micro-payment computer server 340, which is ordinarily implemented in the merchant domain 30 of FIG. 8 under the control of an acquirer, is now moved into issuer domain 10 to become part of dual-payment single-card enablement computer system 800 and performs parts of the protocol handling and adaptation function 820, and of the user authentication function 830. Those parts of 820 and 830 handled by micro-payment computer server 340 depend on the capabilities of the original implementation of micro-payment computer server 340 as a stand-alone module, and the amount of modifications desirable or practical on such computer server.

FIG. 12 shows yet another implementation of a dual-payment single-card enablement computer system 800, in the case that the interchange network 25 needs to account for all transactions, both micro-transactions and macro-transactions. Interchange Compliance Module 840 is added to system 800 to trigger a transaction 845 via Acquirer 35B containing data representing a cumulative amount of micro-transactions that have been previously carried out via data communication protocol 350. The Interchange compliance module acts as a merchant POS module in order to initiate a payment transaction which is authorized and settled through the payment network. This module ensures that all funds drawn from the card account are actually processed through the payment network. One exemplary use of transaction 845 can be to trigger the funding of a reserved purse inside card processing computer platform 155, such purse to be used subsequently for the funding of micro-transactions.

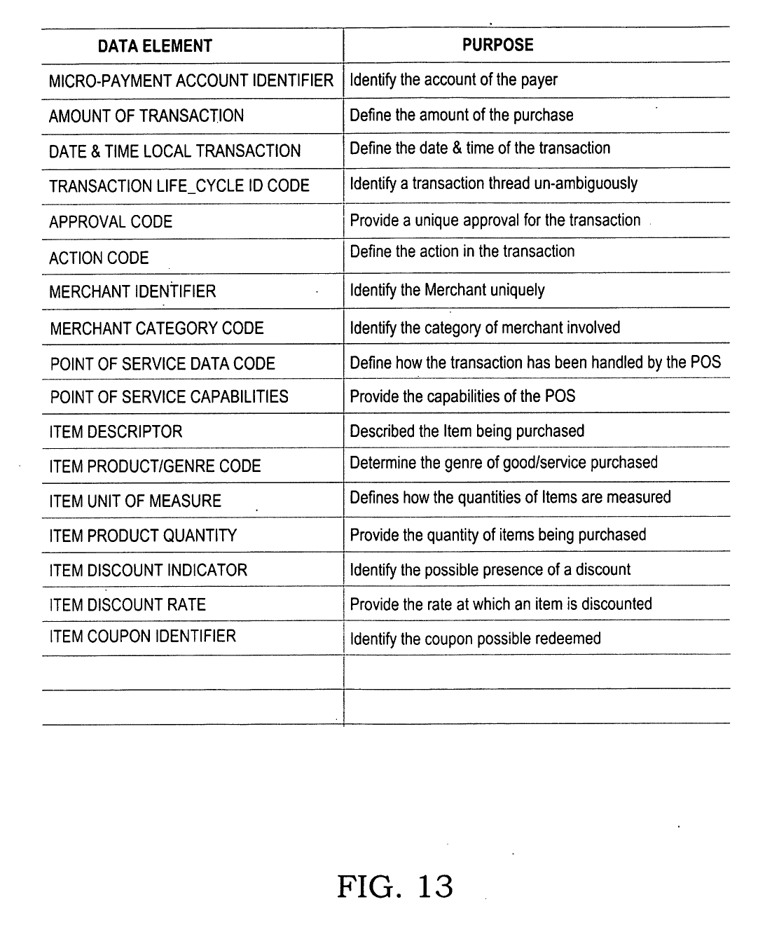

FIG. 13 shows a list of data elements typically transported by micro-payment optimized data communication protocol 350. It should be noted that transport-level data elements such as Message Authentication Codes, Message Sequence Numbers, Origination and Destination Addresses are not included in the list below, for the sake of clarity. Not all data elements in FIG. 13 are mandatory to handle a micro-payment transaction; for example data elements pertaining to the item being purchased are optional and may not be present if the merchant does not wish to disclose to the issuer what items are being purchased from its store.

The Micro-Payment Account Identifier data element identifies the account of the payer i.e. of the card-holder. This could be the Primary Account Number of the card, but is preferably another unique number associated with the account in order not to expose the card number to Internet transactions which might be riskier than card-present transactions at a physical Point Of Service terminal.

The Amount Transaction data element indicates the financial amount of the payment to be carried out.

The Date and Time Local Transaction data element provides a date-and-time-stamp for the transaction.

The Transaction life cycle identification data element is a unique identifier used to match transactions throughout their life cycle, for example to match a chargeback with its preceding authorization.

The Approval Code data element contains the unique code generated by the issuer to approve the transaction.

The Action Code data element indicates the type of action to be undertaken, such as approval or reversal/chargeback.

The Micro-Payment Acceptor Identification Code data element uniquely identifies the Merchant accepting the micro-payment transaction.

The Merchant Category Code data element provides an identifier of the type of business being done by Merchant for this transaction. For example, the MCC can be encoded in accordance with standard ISO 18245 of the background art.

The Point Of Service Data Code data element is used to indicate how the transaction was handled at the Point Of Service. This data element, in conjunction with the Point Of Service Capability, allows the issuer to make appropriate authorization and chargeback decisions. For example, this data element can indicate if the Point Of Service of the merchant obtained the user authentication via a wallet owned and operated by the Merchant or if the user authentication was provided by the issuer.

The Point Of Service Capability data element is used to indicate the capabilities of the point of service, such as, for example, the presence of a wallet, the version number of the http protocol re-direction capabilities of the POS, etc.

The Item Descriptor data element provides a detailed description of the item purchased, as provided by the Merchant.

The Item Product/Genre Code data element provides a categorization of the item being purchased, as defined by the Merchant.

The Item Unit Of Measure data element provides the unit of measurement of the item quantities, for example “tracks” (of music) “hours and minutes” (of game-play).

The Item Product Quantity data element defines the amount of item purchased, according to the Item Unit Of Measure.

The Item Discount Indicator data element defines the presence or absence of a discount on the purchased item, as defined by the Merchant.

The Item Discount Rate data element defines the rate at which the item is discounted, as defined by the Merchant.

The Item Coupon Identifier data element provides the code of a coupon redeemed during the purchase of the item.

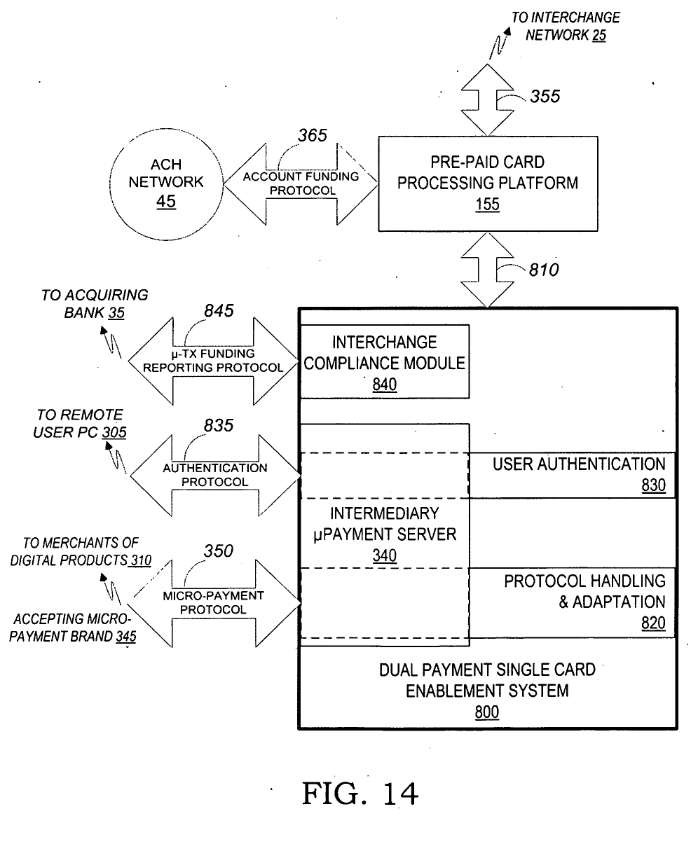

In order to illustrate how a dual-payment single-card enablement system according to the present invention can interact with existing commerce participants of the background art, reference is made to FIG. 14 depicting how dual-payment single-card enablement computer system 800 can interface with a pre-paid card processing computer platform 155 of the background art and enable electronic micro-payment transactions with merchants of digital goods 310 accepting established micro-payment brand 345.

Funding of the payer's account inside pre-paid card processing computer platform 155 is handled by the transfer of funds from the bank of the payer or from the payer's parents or tutors if the payer is a minor (not shown), via ACH network 45 of the background art and data communication protocol 365. Once access to funds has been ascertained by the pre-paid card processing computer platform, online micro-purchases can take place at merchant 310 of digital products via data communication protocol 350. It is assumed here that merchant 310 is unable to verify the identity of payer by itself, and delegates the authentication of the payer via his/her Personal Computer 305 to module 830 of the dual-payment single-card enablement computer system 800 via data communication protocol 835. It is also assumed that merchant 310 already accepts micro-payment brand 345, therefore, dual-payment single-card enablement computer system 800 includes intermediary micro-payment computer server 340 to handle the required compatibility with acceptance brand 345 via data communication protocol 350. Each micro-payment is communicated to pre-paid processing computer platform 310 via data communication protocol 810 to ensure that proper decrementing of available funds takes place with each purchase. As the operator of pre-paid computer platform 310 and interchange network 25 may require that micro-purchases be visible via protocol 355 in spite of the fact that such micro-purchases take place via separate data communication protocol 350, interchange compliance module 840 can trigger a macro-transaction via protocol 845 towards an acquirer 35, where data elements in the macro-transaction represent a cumulative number of micro-purchases having taken place individually through data communication protocol 350. Such constructed macro-transaction will come back to the pre-paid platform 310 via interchange network 25, as any other macro-transaction of the background art.

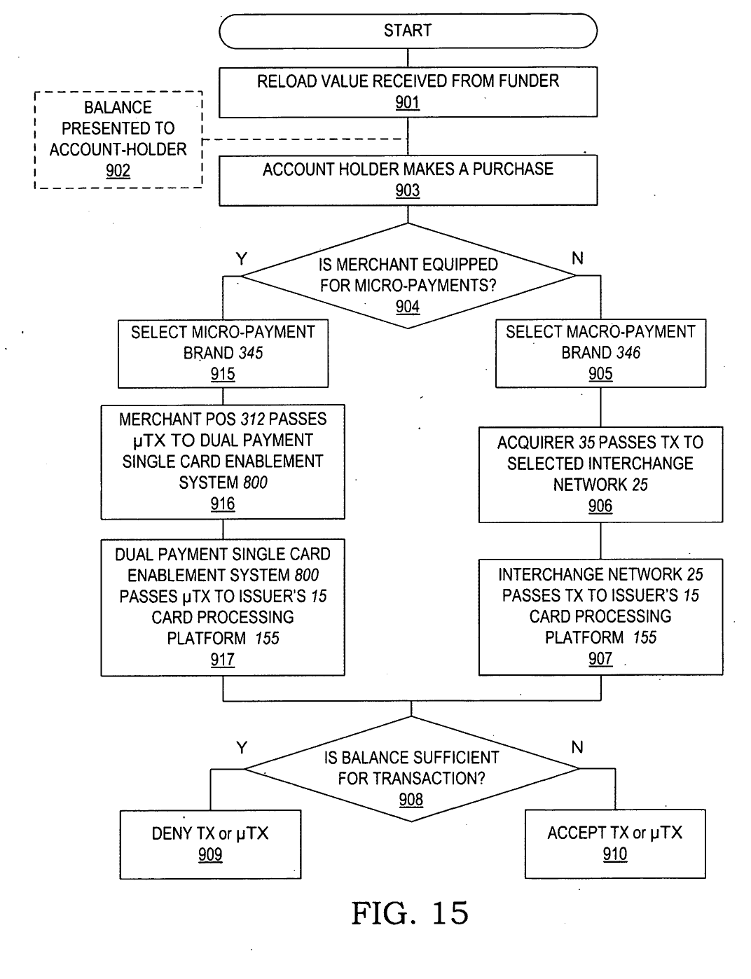

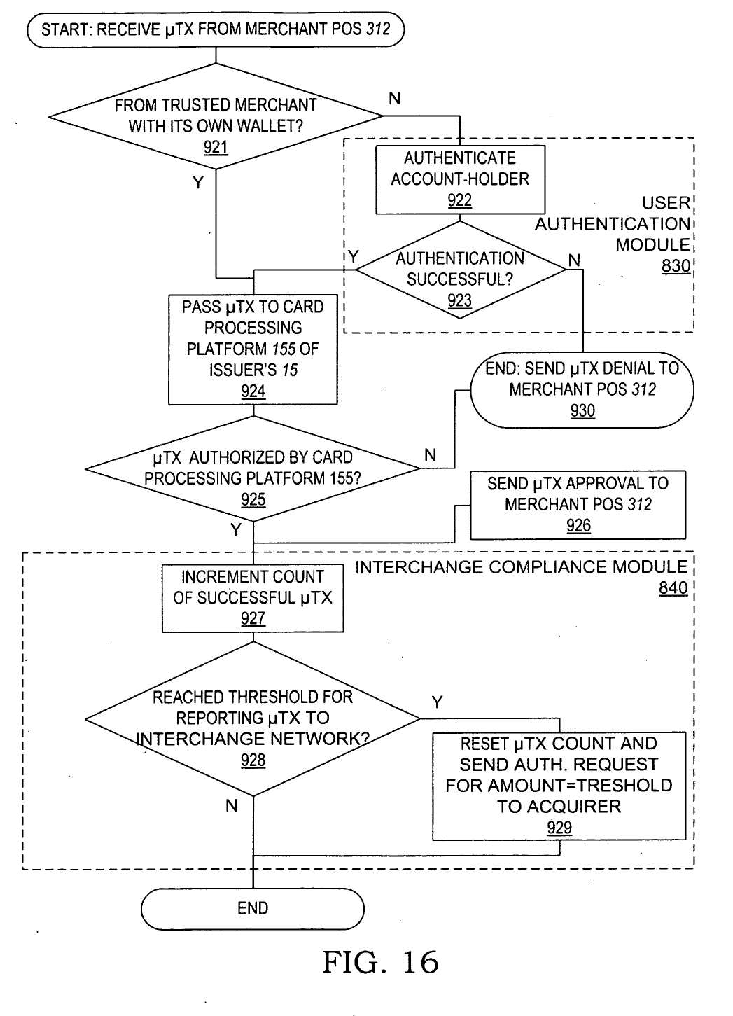

Reference is made to FIG. 15 for a typical sequence of events occurring during the use of the system of the present invention. Prior to any purchases, the account of the payer must be loaded with funds in step 901. From then on the account holder is ready to initiate a purchase in step 903. Optionally, before making a purchase, the account holder may verify the balance of his/her account in step 902. If a purchase is made at a merchant not equipped for micro-payments, then the acceptance brand selected in step 905 for the intended payment is macro-payment brand 346 of FIG. 8 related to the appropriate Interchange Network 25 of FIGS. 8, 9, 12. Acquirer 35 of FIGS. 8, 9 & 12 passes the details of the requested transaction onto Issuer 15 of FIGS. 9 & 12 through Interchange Network 25 via steps 906 and 907. If a purchase is made at a merchant equipped for micro-payments, then the acceptance brand selected in step 915 for the intended payment is micro-payment brand 345 of FIG. 8. The Merchant POS 312 of FIGS. 8 &9 passes the data elements of the requested transaction onto Issuer 15 of FIGS. 9 & 12 through data communication protocol 350 of FIGS. 8, 9,10,11 & 12 via steps 916 and 917. Card Processing Computer Platform 155 of FIGS. 9 & 12 can then take step 908 of verifying that the account balance is sufficient for the intended transaction and decline it in step 909 or approve it in step 910 accordingly.

Reference is made to FIG. 16 for a detail of the processing carried out during step 917 of FIG. 15 by Dual-Payment Single-Card Enablement Computer System 800 of the present invention. In a first step 921, the computer program in system 800 determines if the micro-transaction request comes from a trusted merchant of type 310D of FIG. 10 with its own electronic wallet and user authentication capabilities, or if it comes from a merchant of type 310E of FIG. 10 without user authentication capabilities of its own. Accordingly, the system will authenticate the account holder in step 922 and decide to carry on with the processing in step 923 or decline the transaction in case of authentication failure.

In step 924, the system passes the micro-transaction for further authorization by Card Processing Computer Platform of FIGS. 9 & 12.

In step 925, the system verifies the result of the authorization and either passes the resulting denial in step 930 or the resulting approval in step 926 back to the merchant POS.

FIG. 16 also applies to the case where the Dual-Payment Single-Card Computer System 800 of the present invention features an interchange compliance module 840. The interchange compliance module 840 behaves like a virtual merchant although it is implemented in the issuer domain: after having determined that the micro-transaction was authorized, the system increments the count of successful micro-transactions in step 927 and checks it against a pre-set cumulative threshold in step 928. If the threshold is reached, then the system requests an authorization for an amount equal to the threshold in step 929 by sending the authorization request via an Acquirer 35 of FIGS. 8, 9 & 12, as if it was a merchant.

While the invention has been described with respect to a limited number of embodiments, it will be appreciated by persons skilled in the art that the present invention is not limited by what has been particularly shown and described herein. Rather the scope of the present invention includes both combinations and sub-combinations of the various features described herein, as well as variations and modifications which would occur to persons skilled in the art upon reading the specification and which are not in the prior art.

1. An electronic transactions system applicable for regular retail or online purchases of goods and services and online purchases of goods and services of small monetary value, the electronic transactions system comprising:
a dual payment single card system having an interface to one or more online merchants of small-value items that are linked to a computer of a remote payor, an interface to a system of an account holder of the payor and a data communication protocol, that does not transit through a third-party acquirer or a third-party interchange network, for the purpose of authenticating the payor, and authorizing and processing directly small value payments out of the payor account; and
a single data repository, within the system of the account holder of the payor, that contains all of funds available for both online purchases of small value items authorized via the said data communication protocol, and one or more purchases of an item of any value authorized via a payment card acquirer and a set of associated interchange networks.

2. The electronic transactions system of claim 1, wherein the account of the payor is addressable by the payor, a card issuer, a merchant, an acquirer and a fund provider, by presenting an electronic address comprising a payment card Primary Account Number for all operations except certain small-value purchases from online merchants not willing or able to capture card numbers.

3. The electronic transactions system of claim 1, wherein said data communication protocol further comprises a two-way protocol between online merchants of small-value items and the system of the account holder of the payor when the authentication of the online users can be handled directly by the merchant before requesting a payment authorization.

4. The electronic transactions system of claim 1, wherein said data communication protocol further comprises a product identification data element sent from the merchant to the account holder of the payor in order to enable subsequent customer relationship management actions by the account holder in case of incidents during the fulfillment of the small-value items purchased.

5. The electronic transactions system of claim 4, wherein the account holder is one of a payment card issuer and an agent of the payment card issuer.

6. The electronic transactions system of claim 1, wherein the account of the payor at the account holder is prepaid and contains reserved funds provided by a third party payer.

7. The electronic transactions system of claim 6, wherein the third party payer further comprises a relative of the account holder including one of a parent and a custodian.

8. The electronic transactions system of claim 1, wherein authorizations for small purchases obtained directly from the account holder system are aggregated to form an macro-transaction authorization request that is authorized using an interchange network.

9. The electronic transactions system of claim 1, wherein said data communication protocol between online merchants of small-value items and the system of the account holder also includes a first step of translating a request to debit a small amount from a proprietary acquirer account such as a merchant store card or a dedicated Internet currency account into an authorization to debit the same value from the payer's account held by the card issuer or its agent.

10. An electronic transactions method used for regular retail or online purchases of goods and services and online purchases of goods and services of small monetary value, the electronic transactions method comprising:
providing an interface to one or more online merchants of small-value items that are linked to a computer of a remote payor;
providing an interface to a system of an account holder of the payor,
providing a single data repository, within the system of the account holder of the payor, that contains all of funds available for both online purchases of small value items authorized via the a data communication protocol, and one or more purchases of an item of any value authorized via a payment card acquirer and a set of associated interchange networks; and
authenticating the payor and authorizing a small value payment out of the payor account using a data communication protocol that does not transit through a third-party acquirer or a third-party interchange network.

11. The electronic transactions method of claim 10 further comprising addressing, by presenting an electronic address comprising a payment card Primary Account Number for all operations except certain small-value purchases from online merchants not willing or able to capture card numbers, the account of the payor by one of the payor, a card issuer, a merchant, an acquirer and a fund provider.

12. The electronic transactions method of claim 10 further comprising authenticating the online users by the merchant and wherein said data communication protocol further comprises a two-way protocol between online merchants of small-value items and the system of the account holder of the payor.

13. The electronic transactions method of claim 10, wherein said data communication protocol further comprises a product identification data element sent from the merchant to the account holder of the payor in order to enable subsequent customer relationship management actions by the account holder in case of incidents during the fulfillment of the small-value items purchased.

14. The electronic transactions method of claim 13, wherein the account holder is one of a payment card issuer and an agent of the payment card issuer.

15. The electronic transactions method of claim 10, wherein the account of the payor at the account holder is prepaid and contains reserved funds provided by a third party payer.

16. The electronic transactions method of claim 15, wherein the third party payer further comprises a relative of the account holder including one of a parent and a custodian.

17. The electronic transactions method of claim 10 further comprising aggregating the authorizations for small value purchases to form an macro-transaction authorization request that is authorized using an interchange network.

18. The electronic transactions method of claim 10, wherein said data communication protocol between online merchants of small-value items and the system of the account holder further comprises translating a request to debit a small amount from a proprietary acquirer account such as a merchant store card or a dedicated Internet currency account into an authorization to debit the same value from the payer's account held by the card issuer or its agent.
